(19) United States
(12) Patent Application Publication
(10) Pub. No.: US 2007/0269568 A1
(43) Pub. Date: Nov. 22, 2007

(54) Reduced calorie sweetener composition with improved aftertaste and method of preparing same

(75) Inventor: Robert M. Beaudry, Tucson, AZ (US)

Correspondence Address: INGRASSIA FISHER & LORENZ, P.C., 7150 E. CAMELBACK, STE. 325, SCOTTSDALE, AZ, 85251, US

(73) Assignee: Robert M. Beaudry, Trustee of the Beaudry Revocable Trust

(21) Appl. No.: 11/437,239

(22) Filed: May 19, 2006

(51) Int. Cl. A23L 1/236

(52) U.S. Cl. 426/548

(57) ABSTRACT

A composition is provided for a reduced calorie sweetener, and a method is provided for the preparation thereof. The sweetener comprises acesulfame potassium (acesulfame K), glycine, erythritol, and at least a portion of a petal from a flower. The method comprises the steps of combining glycine, erythritol, acesulfame K, and at least a portion of a petal from a flower, and mixing the glycine, erythritol, acesulfame K, and the flower petal.

### TECHNICAL FIELD

The present invention generally relates to sweetener compositions, and more particularly relates to a reduced calorie sweetener composition with an improved aftertaste and a method of preparing the composition.

### BACKGROUND

Both artificial and natural sweeteners are popular in today's marketplace. For the calorie-conscious consumer, a number of high intensity, artificial sweeteners have become popular, such as acesulfame potassium (acesulfame K), among various other artificial sweeteners including aspartame, saccharin, thaumatin, alitame, and sucralose. Because acesulfame K is approximately 100 to 200 times sweeter than sucrose, acesulfame K can be used as a sweetening agent in small amounts, with few calories. Acesulfame has also not been the subject of the type of negative publicity associated with certain artificial sweeteners, such as aspartame and saccharin, regarding alleged health issues. However, as typically used acesulfame K has certain disadvantages, such as an undesirable aftertaste.

Various prior efforts have been attempted to reduce the acesulfame K aftertaste. For example, U.S. Patent Application Pub. No. 2002/0051811 A1 (Bakal et al.) discloses use of minerals such as potassium, calcium, magnesium, iron, chromium, copper, and zinc, in an attempt to reduce the acesulfame K aftertaste.

In another example, U.S. Patent Application Pub. No. 2002/0187233 A1 (Mann et al.) discloses use of a food starch-modified syrup and/or food starch-modified syrup solids, and optionally the addition of various mineral compositions such as picolinate, citrate, gluconate, glutamate, chloride, carbonate, malate, phosphate, chelidamate, magnesium, calcium, boron, manganese, chromium, copper and/or zinc salts, in an attempt to reduce the aftertaste of acesulfame K and other artificial sweeteners.

In yet another example, U.S. Pat. No. 5,106,632 (Wong et al.) discloses use of potassium chloride and one or more grade acids such as fumaric acid, adipic acid, succinic acid, citric acid, butyric acid, capric acid, tartaric acid, and malic acid, in an attempt to reduce the aftertaste of acesulfame K.

In yet another example, U.S. Pat. No. 4,495,170 (Beyts et al.) discloses use of at least one chlorodeoxysugar sweetener selected from the group consisting of chloro-deoxysucrose and chlorodeoxygalactosucrose, along with acesulfame K or other artificial sweeteners, in an attempt to provide a synergized composition with a reduced aftertaste.

In still another example, European Patent Application No. EP 0,122,400 A1 (Nobuo) discloses use of one or more members selected from the group consisting of alanine, glycine, histidine, arginine glutamate, glutamic acid and its sodium salt, sodium 5 min-inosinate, sodium 5 min-guanylate, tartaric acid and its salts, and disodium phosphate, in an attempt to reduce the acesulfame K aftertaste.

However, the efforts to reduce the acesulfame K aftertaste have yet to produce ideal results. For example, the masking agents used with acesulfame K have generally produced less than ideal masking effects, and/or the masking agents have produced their own undesirable aftertastes.

Accordingly, there is a need for a reduced calorie sweetener composition with an improved aftertaste, and a method of preparing the same.

### BRIEF SUMMARY OF THE INVENTION

A composition is provided for a reduced calorie sweetener. In one embodiment, and by way of example only, the composition comprises acesulfame K, glycine, erythritol, and at least a portion of a petal from a flower.

A method is provided for preparing a reduced calorie sweetener. In one embodiment, and by way of example only, the method comprises the steps of combining glycine, erythritol, acesulfame K, and at least a portion of a petal from a flower, and mixing the glycine, erythritol, acesulfame K, and the flower petal.

In another embodiment, and by way of example only, the method comprises the steps of drying at least a portion of a flower petal, crushing the dried flower petal, combining the crushed flower petal with glycine, erythritol, and acesulfame K, and mixing the glycine, erythritol, acesulfame K, and the crushed flower petal.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

TABLE 1 below depicts an exemplary composition for a reduced calorie sweetener with an improved aftertaste.

TABLE 1

| | Ratio of Amount of Ingredient |
|---|---|
| Ingredient | to Amount of Acesulfame K |
| Acesulfame K | 1:1 |
| Erythritol | 12:1 |
| Glycine | 12:1 |
| Flower Petal | 3:100 |

As depicted in Table 1, a preferred embodiment of the sweetener includes acesulfame K, erythritol, and at least a portion of a petal from a flower. The sweetener preferably takes the form of a powder with at least a crystal portion with a texture resembling that of sucrose, and a smooth portion with a texture that is more smooth than that of sucrose. It will be appreciated by one of skill in the art that acesulfame K is an artificial sweetener with a noticeable aftertaste. It will also be appreciated that glycine is an amino acid with a mildly sweet taste, and that erythritol is a sugar alcohol with a taste approximately seventy percent as sweet as sucrose.

As mentioned in the Background section above, various efforts have been made to reduce the aftertaste associated with acesulfame K through use of certain masking agents. However, the masking agents used with acesulfame K have generally produced less than ideal masking effects, and/or the masking agents have produced their own undesirable aftertastes.

In the preferred embodiment of Table 1, glycine is used in the sweetener at least in part to enhance the overall taste of the sweetener. Specifically, the glycine helps to reduce the acesulfame K aftertaste, and to add sweetness. In addition, the glycine helps to improve the texture of the sweetener, for example by contributing to the smooth portion of the blend of ingredients in powder form. USP grade glycine is used in the sweetener.

The erythritol is used in the sweetener at least in part to help mask the aftertaste of the acesulfame K in the sweetener, and to add sweetness. In addition, the erythritol improves the texture of the sweetener, for example by contributing to the crystal part of the blend of ingredients, providing a familiar sugar-like texture to the sweetener. However, when used in this manner, the erythritol may leave its own aftertaste, and/or may not completely mask the acesulfame K aftertaste.

The flower petal is used in the sweetener at least in part to alleviate the remaining aftertaste from the acesulfame K, glycine, and erythritol combination. The flower petal also adds to the essence of the sweetness. At least a portion of a flower petal is used, although it will be appreciated that an entire flower petal, multiple flower petals, or portions thereof, can be used, either from one flower or a plurality of flowers. Preferably the flower petal is dried and crushed prior to being combined with the acesulfame K, glycine, and erythritol. In a preferred embodiment the flower petal is from a violet, a rose, or a lavender. However, it will be appreciated that the flower petal can be from any of a number of different types of flowers, or combinations thereof.

In the preferred embodiment depicted in Table 1 above, the ratio of the amount of glycine to the amount of acesulfame K in the sweetener is approximately 12:1. The sweetener preferably includes approximately the same amount of erythritol as glycine. Accordingly, the ratio of the amount of erythritol to the amount of acesulfame K in the sweetener is also approximately 12:1 in this preferred embodiment. Finally, the ratio of the flower petal to the acesulfame K in this preferred embodiment is approximately 3:100. In certain embodiments the ratio of the flower petal to the acesulfame K can be reduced, for example to approximately 3:250 or to approximately 1:100, when less of the flower petal is desired. Alternatively, the ratio of the flower petal to the acesulfame K can be increased, for example to approximately 3:50 or 1:10 or higher, when more of the flower petal is desired, such as in a candied version of the sweetener. It will be appreciated that the above-referenced ingredients can be utilized in any one of a number of different ratios. However, the formulations referenced above, including the embodiment depicted in Table 1, yielded unexpected results in the form of exceptional taste, believed to be a product of synergistic qualities of the above ingredients.

In a preferred embodiment, the sweetener is prepared utilizing the steps described below. First, a base formula is created by combining the glycine and the erythritol together, preferably in approximately equal amounts. As mentioned above, USP grade glycine is used. Next, the acesulfame K is combined with the glycine and erythritol, preferably in an amount that is approximately one-twelfth the amount of the glycine, and approximately one-twelfth the amount of the erythritol.

In addition, at least a portion of a flower petal, or multiple flower petals, is collected. As mentioned above, in a preferred embodiment the flower petal is from a violet, a rose, or a lavender; however, it will be appreciated that the flower petal can be from either one flower or a plurality of flowers, and can be from any of a number of different types of flowers, or combinations thereof. Preferably the flower petal is dried and then crushed. However, it will be appreciated that the flower petal can be prepared using any one of a number of different methods. It will also be appreciated that the preparation of the flower petal can occur before, after, or simultaneously with the mixing of the other ingredients, and that in certain embodiments the flower petal can come pre-prepared, with no additional drying, crushing, or other preparation required.

Regardless of the particular aspects of the flower petal and the preparation thereof, the flower petal is combined with the glycine, erythritol, and acesulfame K, for example in a mixing apparatus. As mentioned above, in a preferred embodiment depicted in Table 1, the amount of the flower petal used is approximately three one-hundredths of the amount of acesulfame K used in the mixture. Also as mentioned above, the amount of the flower petal can vary, for example decreasing to approximately three parts flower petal per 250 parts acesulfame K or to approximately one part flower petal per 100 parts acesulfame K when less flower petal is desired, or increasing to one part flower petal per 50 parts acesulfame K, or to one part flower petal per 10 parts acesulfame K, or higher, for a candied version of the sweetener.

After the glycine, erythritol, acesulfame K, and flower petal are combined together, the ingredients are mixed together in the mixing apparatus. In a preferred embodiment, these ingredients are blended together in a pneumatic shaker that performs approximately 700 cycles per minute. Preferably the glycine, erythritol, acesulfame K, and flower petal are blended for at least approximately three minutes in the pneumatic shaker, in order to ensure a thorough blend of these ingredients. However, it will be appreciated that any one of a number of different types of shakers, blenders, and/or other mixing apparatus, or combinations thereof, can be used, and for any of a number of different lengths of time. It will also be appreciated that the ingredients can be mixed together at the same time, or that certain ingredients can be mixed with one another separately from other ingredients. It will similarly be appreciated that the steps set forth above can be conducted in a different order (such as the order that the different ingredients are combined and mixed together), and that various steps (such as combining and/or mixing some or all of the ingredients) can also be conducted simultaneously.

As mentioned above, the combination of the glycine, erythritol, acesulfame K and flower petal exhibited synergistic qualities with unexpected results in the form of exceptional taste, which was not present until each of these ingredients were combined together. In addition to the exceptional taste, the sweetener has a pleasant texture, including a crystal portion resembling the texture of table sugar, and a complementary smooth portion of the sweetener. This provides a pleasing feel and taste when the sweetener is consumed. Moreover, each of the ingredients combined with the acesulfame K (namely the glycine, erythritol, and flower petal) are natural ingredients, and each of the ingredients are generally considered to be healthy for consumption. Accordingly, the sweetener maintains an exceptional taste and a pleasant texture, without using multiple artificial sweeteners, and without using certain artificial sweeteners, such as aspartame or saccharin, that have garnered substantial negative publicity.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A reduced calorie sweetener comprising:
acesulfame potassium (acesulfame K);
glycine;
erythritol; and
at least a portion of a petal from a flower.

2. The sweetener of claim 1, wherein the flower comprises a violet.

3. The sweetener of claim 1, wherein the flower comprises a rose.

4. The sweetener of claim 1, wherein the flower comprises a lavender.

5. The sweetener of claim 1, wherein the flower petal is dried.

6. The sweetener of claim 1, wherein the ratio of the glycine to the acesulfame K in the sweetener is about 12 parts glycine per one part acesulfame K.

7. The sweetener of claim 1, wherein the ratio of the erythritol to the acesulfame K in the sweetener is about 12 parts erythritol per one part acesulfame K.

8. The sweetener of claim 1, wherein the ratio of the flower petal to the acesulfame K in the sweetener is about 3 parts flower petal per 100 parts acesulfame K.

9. The sweetener of claim 1, wherein the ratio of the flower petal to the acesulfame K in the sweetener is at least 1 part flower petal per 100 parts acesulfame K.

10. The sweetener of claim 1, wherein the ratio of the flower petal to the acesulfame K in the sweetener is at least 3 parts flower petal per 50 parts acesulfame K.

11. A method for preparing a reduced calorie sweetener, the method comprising the steps of:
(a) combining glycine, erythritol, acesulfame potassium (acesulfame K), and at least a portion of a petal from a flower;
(b) mixing the glycine, erythritol, acesulfame K, and the flower petal.

12. The method of claim 11, further comprising:
drying the flower petal.

13. The method of claim 11, further comprising:
crushing the flower petal.

14. The method of claim 11, wherein the flower comprises a violet.

15. The method of claim 11, wherein the flower comprises a rose.

16. The method of claim 11, wherein the flower comprises a lavender.

17. The method of claim 11, wherein step (a) comprises combining about 12 parts glycine per one part acesulfame K.

18. The method of claim 11, wherein step (a) comprises combining about 12 parts erythritol per one part acesulfame K.

19. The method of claim 11, wherein step (a) comprises combining about 3 parts flower petal per 100 parts acesulfame K.

20. The method of claim 11, wherein step (a) comprises combining at least 1 part flower petal per 100 parts acesulfame K.

21. The method of claim 11, wherein step (a) comprises combining at least 3 parts flower petal per 50 parts acesulfame K.

22. A method for preparing a reduced calorie sweetener, the method comprising the steps of:
(a) drying at least a portion of a flower petal;
(b) crushing the dried flower petal;
(c) combining the crushed flower petal with glycine, erythritol, and acesulfame potassium (acesulfame K); and
(d) mixing the glycine, erythritol, acesulfame K, and the crushed flower petal.

23. The method of claim 22, wherein the flower is selected from the group consisting of a violet, a rose, and a lavender.

24. The method of claim 22, wherein:
the ratio of the glycine to the acesulfame K in the sweetener is about 12 parts glycine per one part acesulfame K;
the ratio of the erythritol to the acesulfame K in the sweetener is about 12 parts erythritol per one part acesulfame K; and
the ratio of the flower petal to the acesulfame K in the sweetener is at least 1 part flower petal per 100 parts acesulfame K.
